(19) United States
(12) Patent Application Publication
(10) Pub. No.: US 2005/0138736 A1
(43) Pub. Date: Jun. 30, 2005

(54) Multi-purpose kitchen utensil

(76) Inventor: Kenneth A. Tarlow, Corte Madera, CA (US)

Correspondence Address: KENNETH A. TARLOW, 21 GOLDEN HIND PSG., CORTE MADERA, CA, 94925, US

(21) Appl. No.: 10/749,066

(22) Filed: Dec. 31, 2003

(51) Int. Cl. B25F 1/00

(52) U.S. Cl. 7/110

(57) ABSTRACT

Multi-purpose Kitchen Utensil with a flat spatula member that incorporates the elements of a standard spatula, a knife and a grater. A first and second pair of handle members are joined to each other at one end. The first handle member terminates at its opposite end in a scoop member. The second handle member terminates at its opposite end in the flat spatula member. The handle member is foldable at the joined junction so that the handles rest on top of each other and the spatula member rests intimately on the top perimeter of the scoop. The first and second handle members have hollowed portions to allow for the storage of a plurality of kitchen tools. A preferred embodiment includes an elastic cord member that hingedly attaches the first handle member to the second handle member.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of kitchen utensils and more specifically to a multi-purpose kitchen utensil. Utensils and tools that help facilitate cooking and related activities that take place in a standard kitchen or camp site, have been available in the market place for scores of years. Most people have at least a dozen kitchen tools stored in drawers, on counter tops and hanging from wall or ceiling hooks. Campers also must pack a collection of kitchen related tools when going for an extended trip. The common kitchen tools include knives, serving spoons, graters, can openers, bottle openers, vegetable peelers, cork screws, strainers measuring spoons and the like. While all these tools perform their jobs adequately, they occupy a substantial amount of storage space. Additionally, they are expensive when purchased separately. Also, they are cumbersome and relatively heavy when taken as a collection of utensils. Finally, existing utensil designs are not designed to nest into one another so that they take up the minimum amount of space when stored collectively. Although Cynthia Simpson's U.S. Pat. No. 4,823,419, now abandoned, describes a foldable, multi-purpose utensil, it does not include all the utensils that are commonly needed in a typical kitchen or camping trip. There is no provision for storing tools in the handle portion. Additionally, there is no provision for having the flat spatula member and spoon member to act together to be an efficient tongs because the curved spoon shape does not make adequate contact with the straight edged spatula. Additionally, there is no provision to have a nesting coffee making funnel or nesting salt and pepper shaker. Additionally, there is no provision for removing a tool head and replacing it with another tool head. Also, there is no provision for detaching the elastic cord that joins the handle halves together. Finally, there is no mention of a protective case for the device which can also act to removably retain additional kitchen utensils such as a basting brush or fork or salt and pepper shakers. Because of this, the user must have on hand additional utensils thereby increasing the storage space necessary to retain such utensils.

### BRIEF SUMMARY OF THE INVENTION

The primary object of the invention is to provide a kitchen utensil that combines many of the most common kitchen tools into a single device.

Another object of the invention is to provide a kitchen utensil that can fold for compact packaging and storage.

Another object of the invention is to provide a kitchen utensil that allows the user to unplug a utensil from its handle and replace it with another utensil.

Another object of the invention is to provide a kitchen utensil whose handle can separate at a central location so that utensils on each end of the handle can be used separately.

Another object of the invention is to provide a kitchen utensil that is light weight.

A further object of the invention is to provide a kitchen utensil that is easy to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Multi-purpose Kitchen Utensil comprising: a flat spatula member that incorporates the elements of a standard spatula, a knife and a grater, a first and second pair of handle members releasably joined to each other at one end by a resilient cord, said first handle member terminating at its opposite end in a scoop member, said second handle member terminating at its opposite end in said flat spatula member, said handle member being foldable at said releasably joined junction so that said handles rest on top of each other and said flat stainless steel member rests intimately on the top perimeter of said scoop, and said first and second handle members having hollowed portions to allow for the storage of a plurality of kitchen tools. The scoop portion is removable and replaceable from said handle member so that additional tools can be plugged into the socket in said handle member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention showing multiple utensils

FIG. 2 is a side view of the invention in its folded position

FIG. 3 is a partial perspective view showing the cord connector

FIG. 4 is a perspective view of the cork screw of the present invention

FIG. 5 is an exploded view of the spring ball assembly

FIG. 6 is a perspective view of the whisk attachment

FIG. 7 is perspective view of the fork attachment

FIG. 8 is a perspective view of the vegetable peeler of the invention

FIG. 9 is an exploded view of the can opener portion of the invention

FIG. 10 is a side section view of the can opener portion

FIG. 11 is a perspective view of the baster portion attached to the spatula

FIG. 12 is an exploded view of the nesting of the components that fit in the scoop of the invention

FIG. 13 is a perspective view of the coffee maker portion in use

FIG. 14 is a perspective view of the case of the invention shown the multi purpose kitchen tool inside

FIG. 15 is a perspective view of the case in the closed position

FIG. 16 is a perspective view of the tongs feature

FIG. 17 is a perspective view of the scoop portion

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

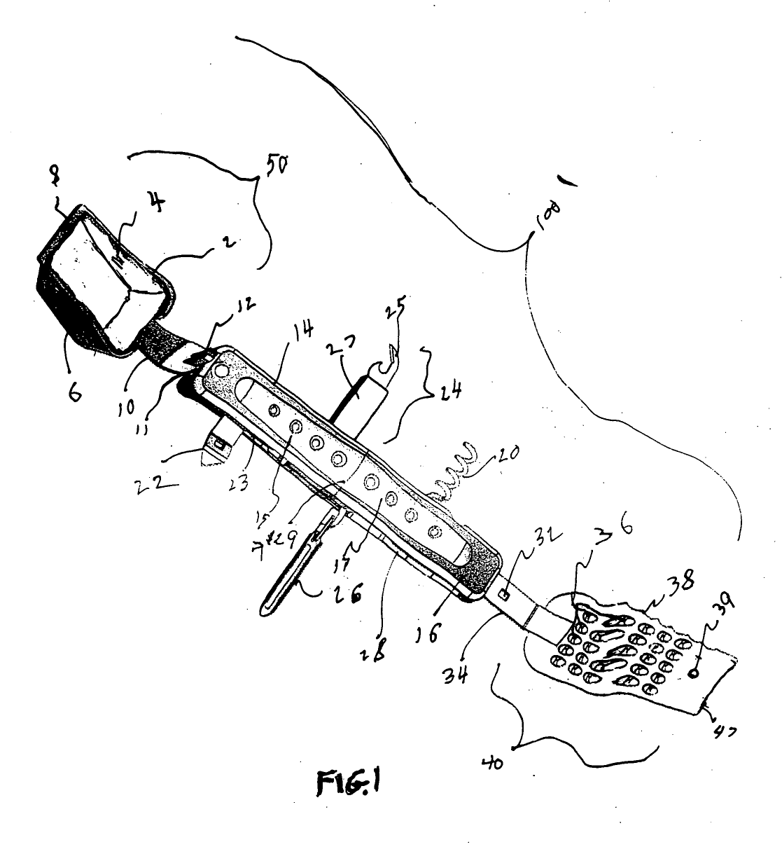

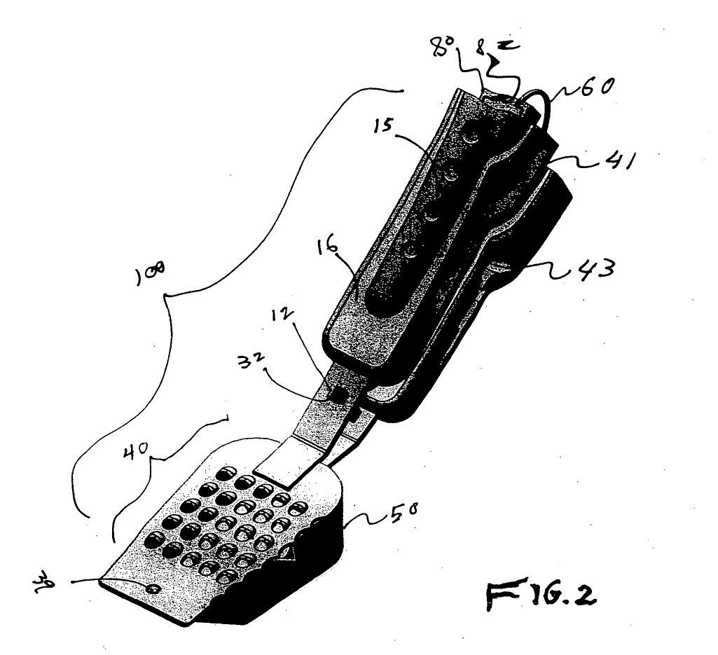

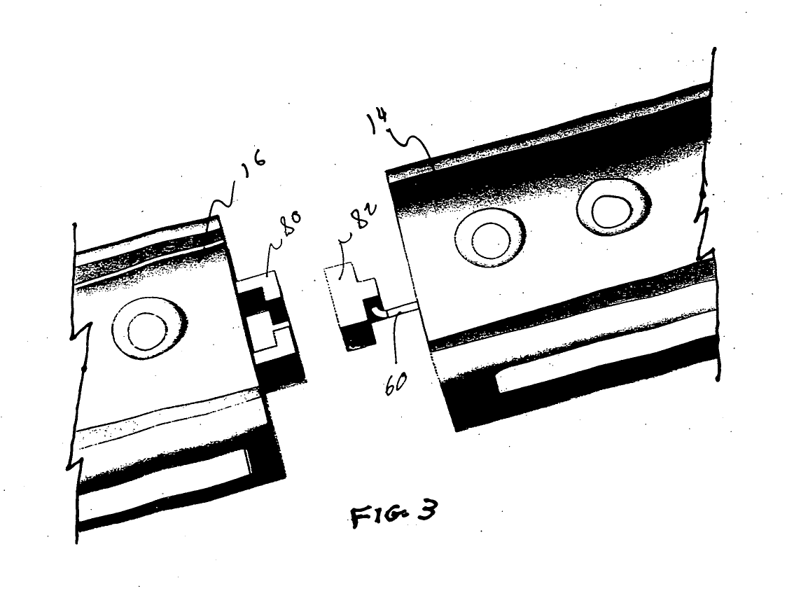

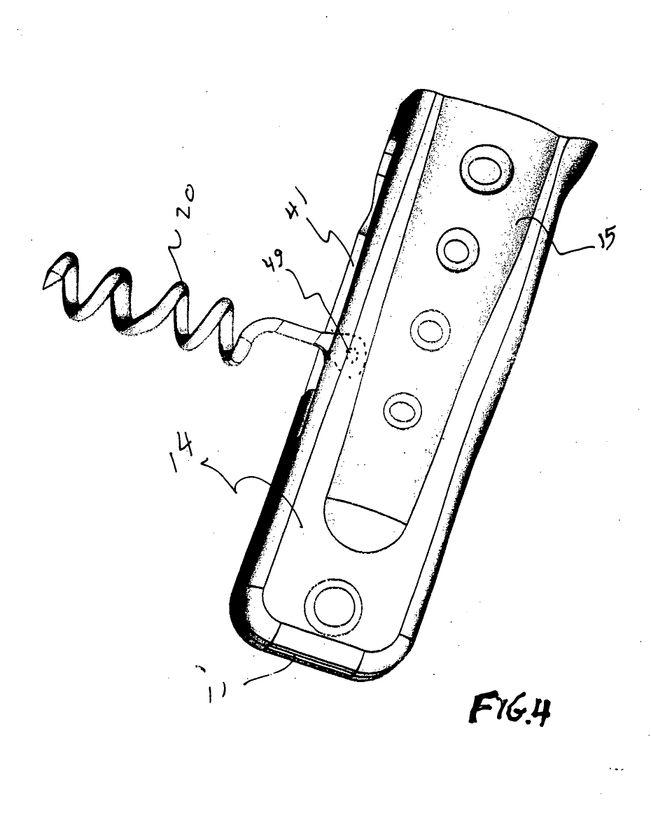

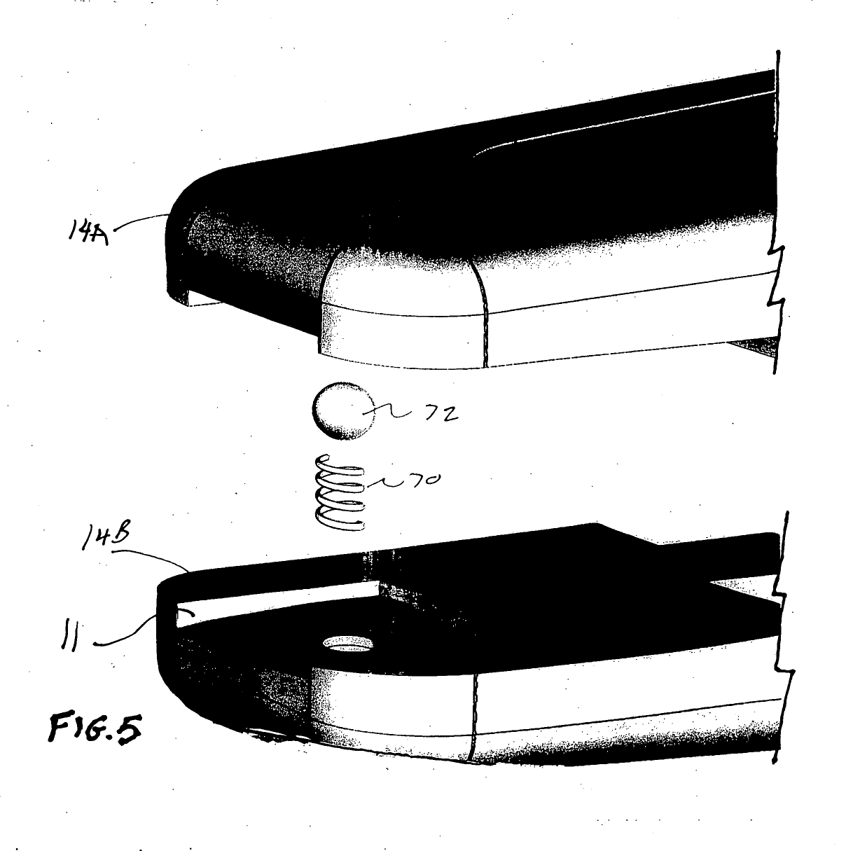

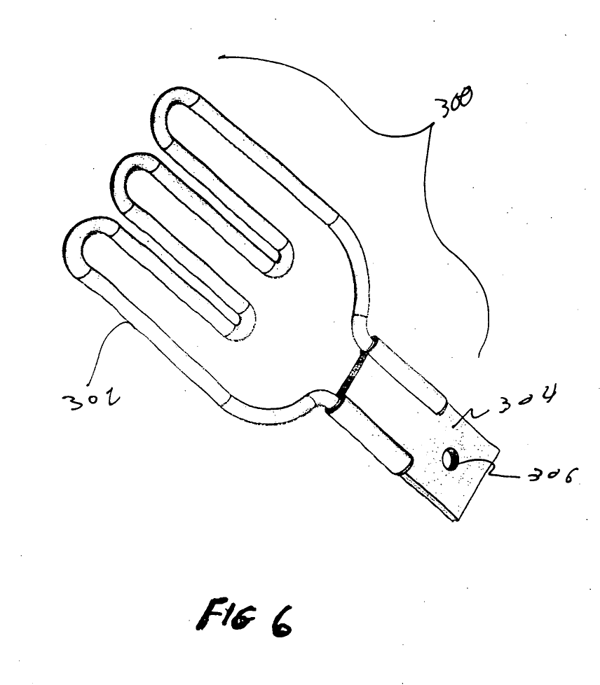

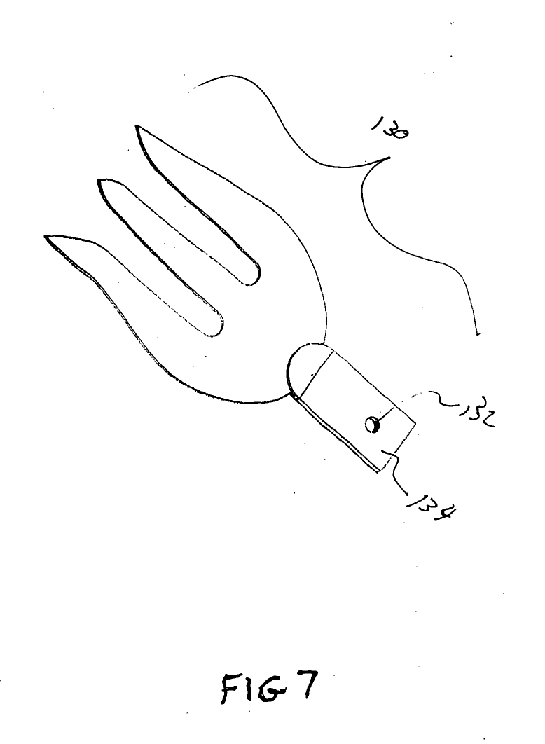

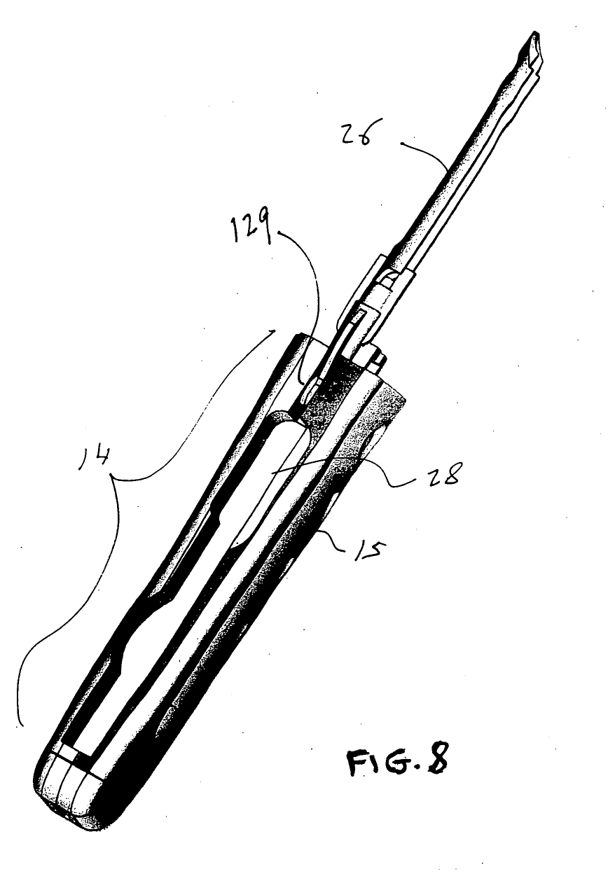

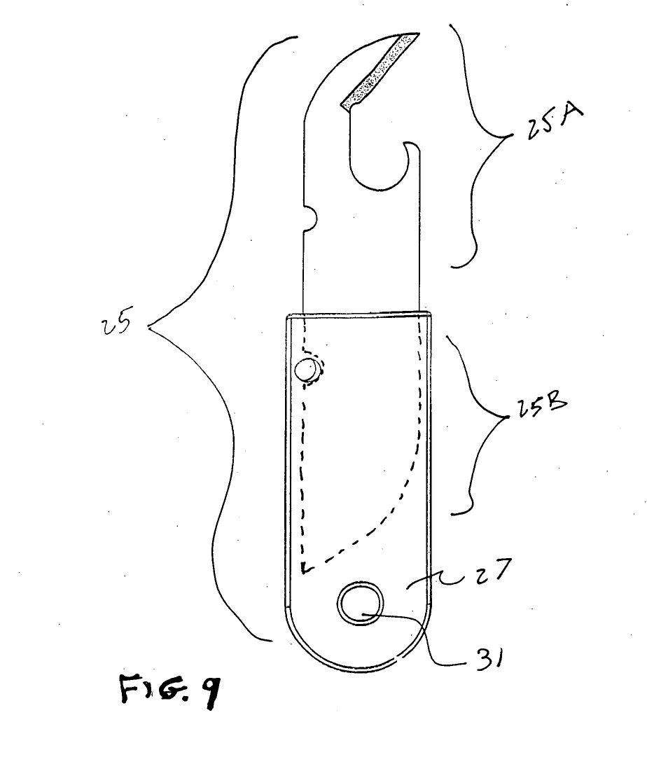

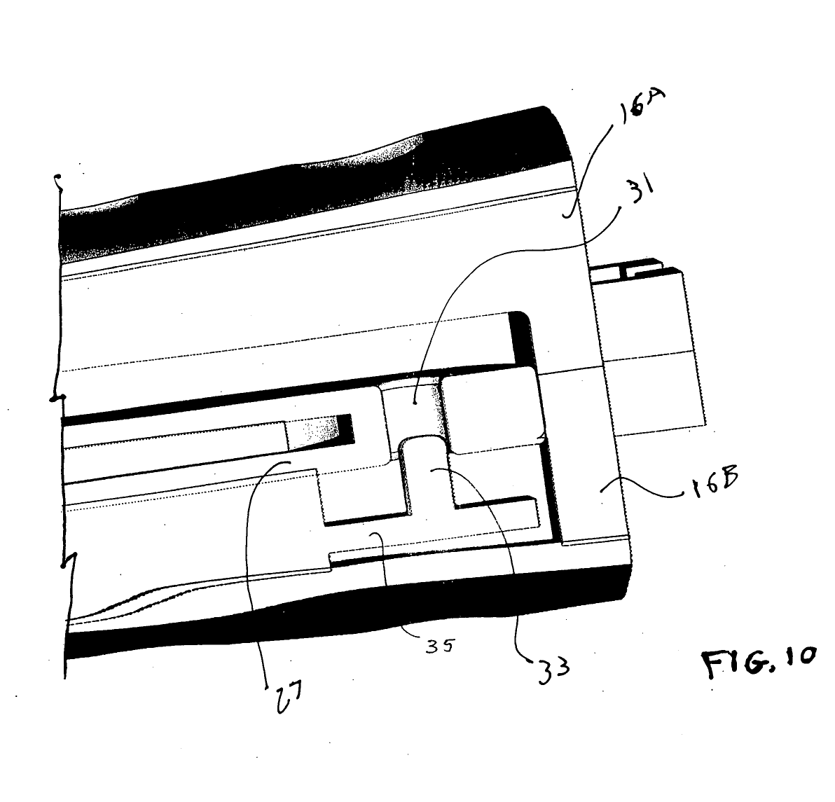

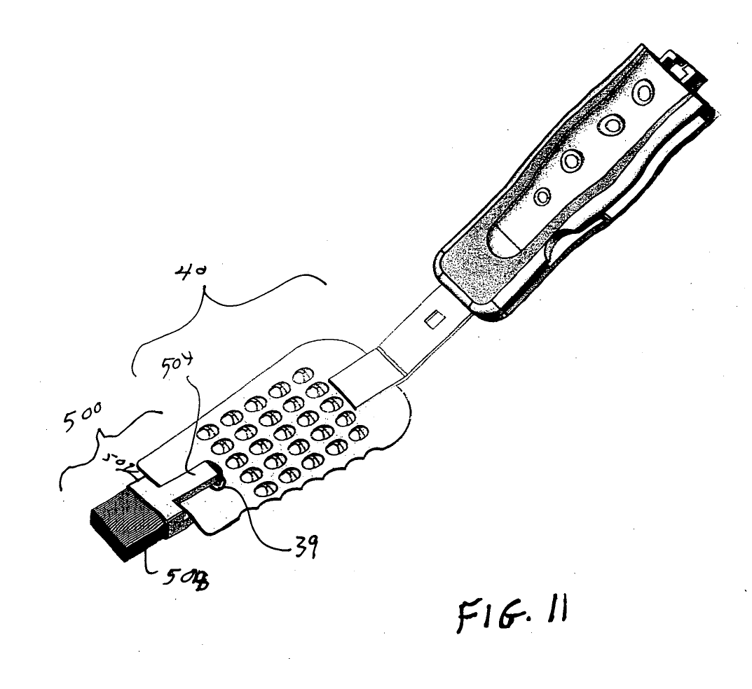

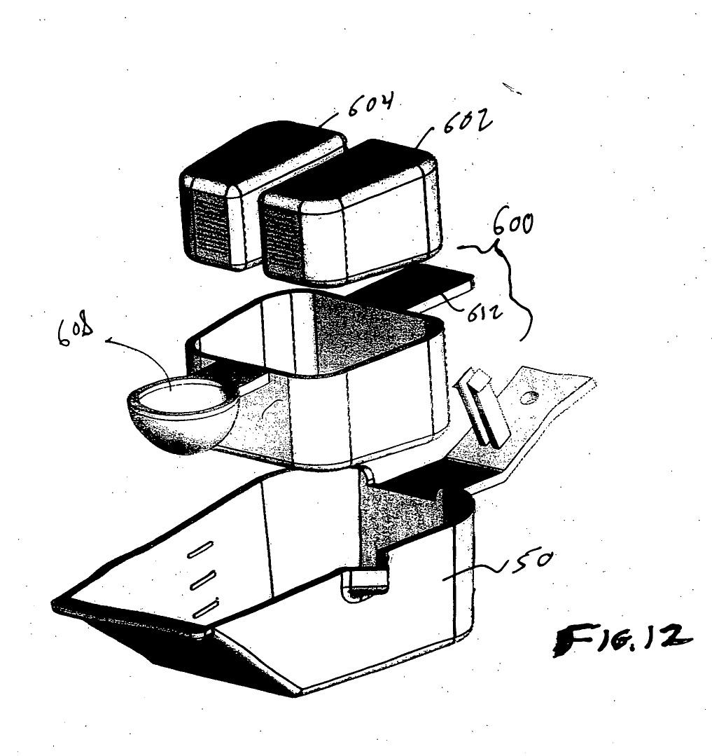

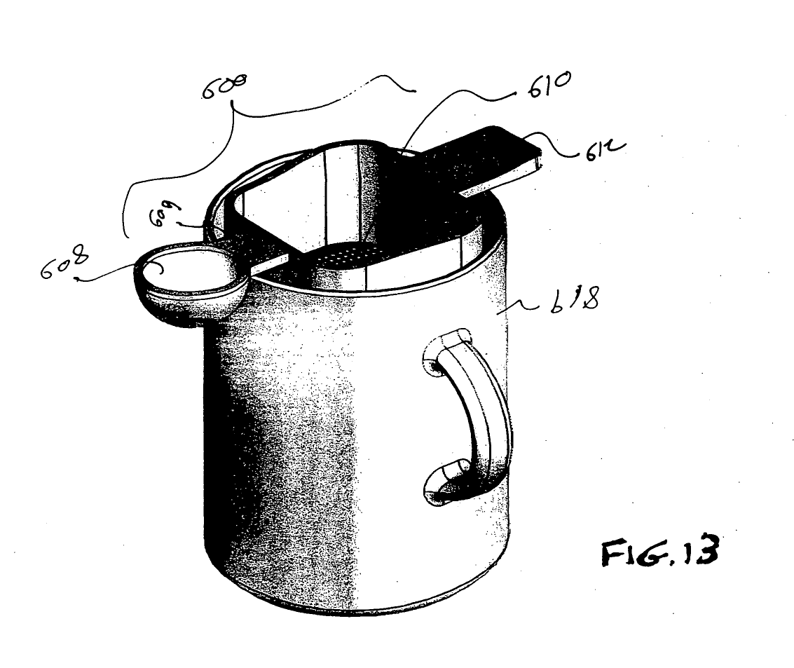

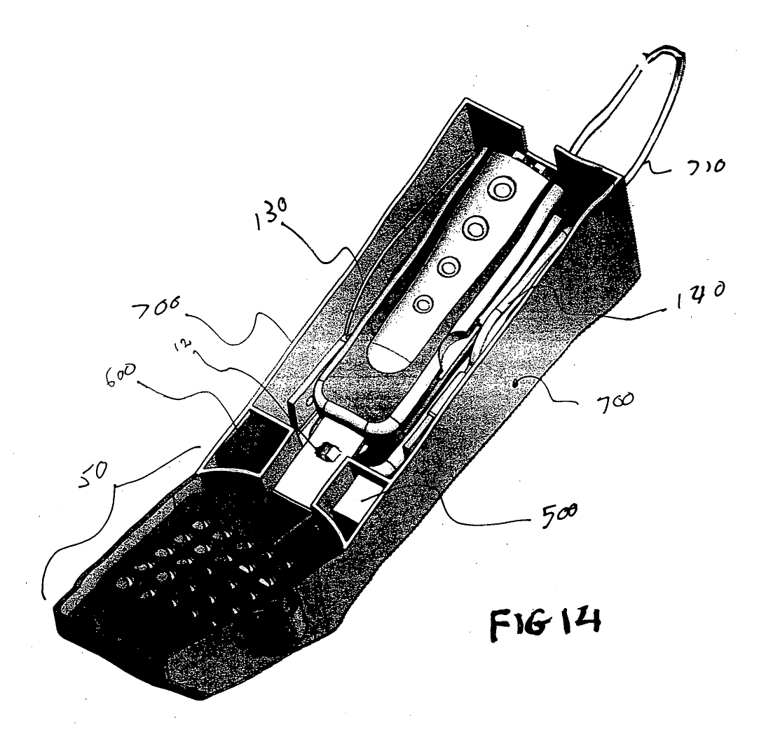

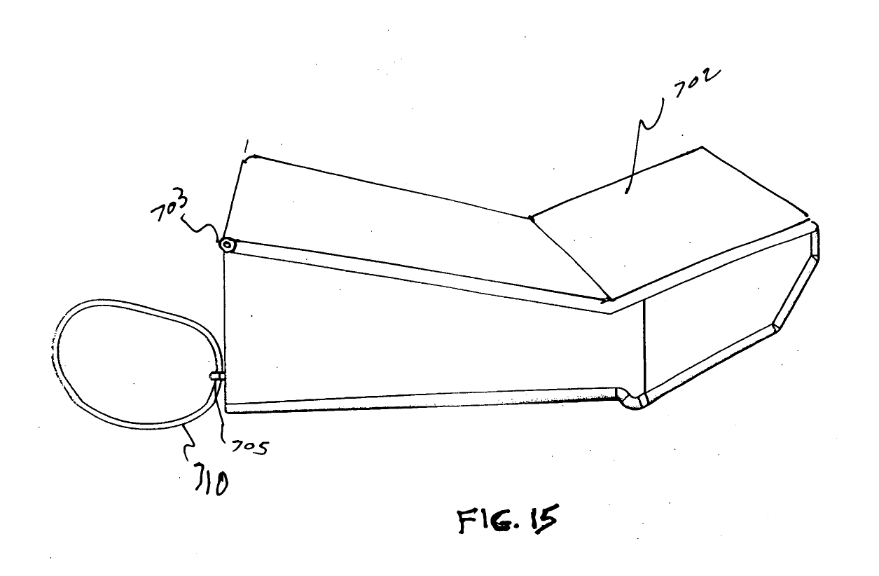

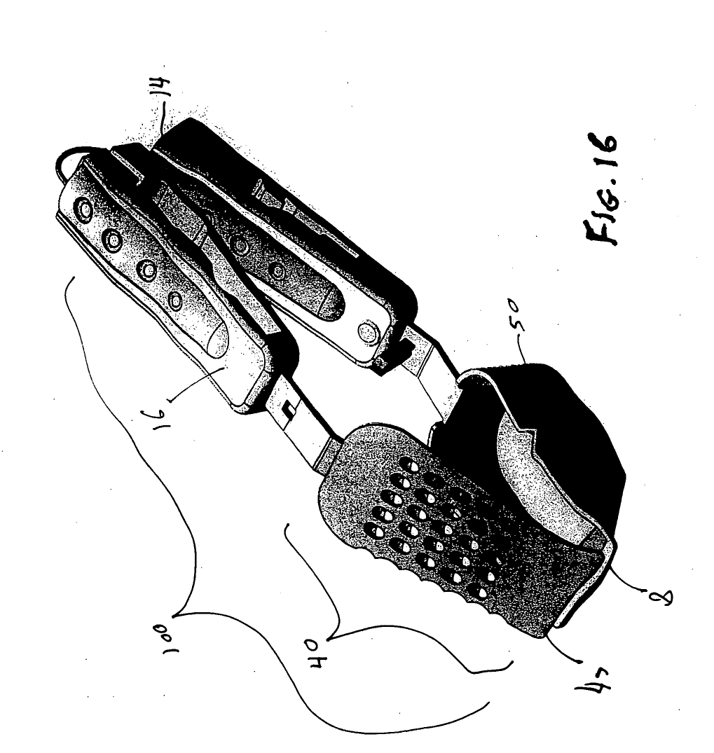

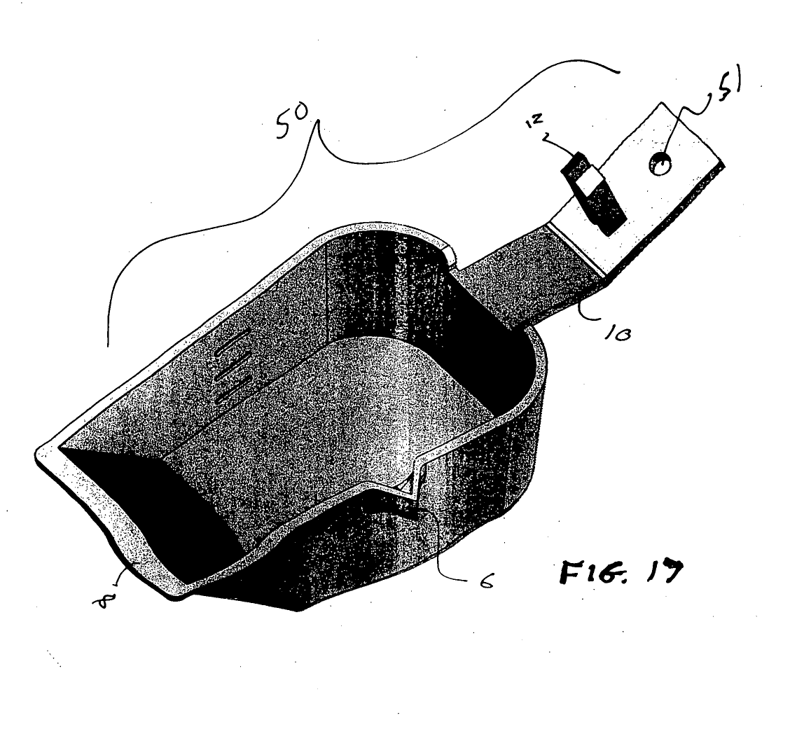

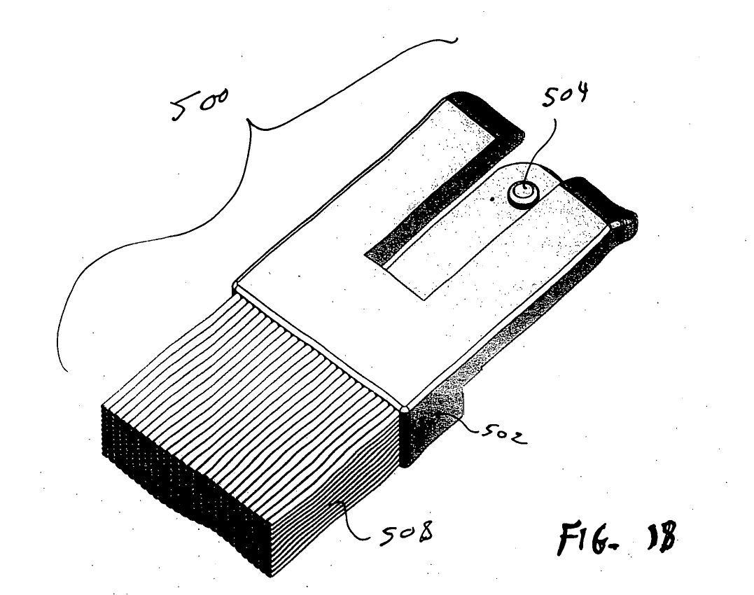

Referring now to FIG. 1 we see a perspective view of the present invention 100. Handle portions 14, 16 are releasably joined at one end 29 as will be described in more detail later. Handle 14 terminates at its opposite end in a removable, replaceable scoop tool 50 that includes a straight leading edge 8, a recessed portion 2 and a ladle type pouring portion 6. One wall of recessed portion 2 includes measuring lines 4 that allow the scoop 50 to be used as a measuring cup. This design allows the scoop 50 to also be used as a measuring cup and a ladle. Scoop 50 is made of molded plastic such as food grade nylon or polypropylene. Shank portion 10 removably inserts into a socket 11 located at the end of handle 14. Tabs 12 mate with square aperture 32 when the two handles are in the folded position as shown in FIG. 2. The handle portions 14, 16 are recessed on their sides 23, 28, 41, 43 to allow storage of a bottle opener 22, a can opener 24 a cork removing tool 20 and a vegetable peeler 26. Handle 16 terminates at its opposite end in a spatula tool 40. Spatula shank 34 is permanently inserted into a recess located at the end of handle 16. Spatula 40 also includes a grater feature 36 and a serrated knife 38. Aperture 39 located at the front portion of spatula 40 allows a basting brush to be removably attached as will be described later. Spatula 40 is made of stainless steel or other flat stamped and sharpened metal or high temperature molded plastic such as nylon or Ultem. Handle portions 14, 16 are made of molded plastic such as ABS and include molded rubber or rubber-like plastic inserts 15 that add to the comfort when gripping the handles. FIG. 2 shows the present invention in its folded position. This folding feature allows the device of the present invention 100 to be stored in a compact manner. Also, in this configuration, the device 100 can be used as a strainer. For example, if a person scooped out cooked peas from a water filled pot using scoop 50, he or she could then trap the peas and water with the spatula portion 40 and, because the perimeter of the spatula 40 and the perimeter of the scoop 50 are similar in shape, the user can turn the assembly 100 upside down and drain the water out of grater apertures 36 without spilling the peas enclosed inside scoop 50. Elastic cord 60 helps keep handles 14, 16 together and acts as a flexible hinge. Cord 60 can be detached and reattached from handle 16 by removing plastic end piece 63 from retaining end piece 61 a is shown more clearly in FIG. 3. Elastic cord 60 is retained at its opposite end within handle 14. FIG. 4 shows handle 14 removed from handle 16 so that the device can be used as a cork removing tool. Cork screw 20 has been radially sung out from recess 41 by pivoting on post 49. FIG. 4 also shows shank accepting aperture 11 more clearly. Scoop 50 as well as other utensils that will be described later are removably retained in handle 14 by use of spring 70 and ball 72 that snaps into an aperture 51 shown in FIG. 17. Of course other known retaining means may be used. FIG. 6 shows a whisk tool 300 made of a wire form 302 welded to a shank 304. Aperture 306 allows the whisk tool to be removably inserted into aperture 11 in handle 14 in a similar fashion as scoop portion 50. Whisk portion 302 is made of relatively heavy gauge wire so that can also be used as a potato masher. FIG. 7 shows a fork utensil 130 made of stainless steel. Its shank 134 also includes an aperture 132 so that it can be removably inserted into aperture 11 of handle 14. By separating handle 14 from handle 16, the user can impale a food object such as a piece of meat, and use the serrated knife portion 38 of spatula tool 40 to cut said meat. FIG. 8 shows vegetable peeler 26 pinned at swivel joint 129 and swung one hundred and eighty degrees out of recess 28 so that it may be used comfortably while gripping handle 14. Handles 14 and 16 have been separated for this application. FIG. 9 shows can opener tool 25 after it has been removed from handle recess 43. Tool 25 can swivel about aperture 29 and be removed from handle 16 because handle 16 includes a spring biased 35 post 33, as shown in FIG. 10, that allows can opener handle 27 to snap in and out. Referring back to FIG. 9, pin 31 can be removed from handle portion 27 so that the can opener end 25A can be removed and turned one hundred and eighty degrees so that paring knife portion 25B is exposed. Pin 31 can be replaced so that knife portion 25B is secure. Of course, other known retaining means can be used instead of pin 31. FIG. 11 shows a basting brush 500 removably attached to the end of spatula 40. Bristles 504 are captured by plastic portion 502. Plastic finger 504 snaps into aperture 39 so that the basting brush is removably secured. FIG. 12 shows an exploded view of scoop 50, coffee maker assembly and salt and pepper containers 602, 604. The coffee maker assembly 600 includes a measuring spoon 608 that can measure a tablespoon and a teaspoon. Salt and pepper containers 604, 602 are shaped to slidably insert into the recess of coffee maker 600 and coffee maker 600 is shaped to slidably fit into the recess of scoop 50. FIG. 13 shows coffee maker 600 in place on a coffee cup 618. The bottom 610 of coffee maker 600 is made of a fine screen material so that coffee grounds are retained but hot water poured over the coffee grounds is allowed to pass through to the coffee cup below. Tab 612 helps hold the coffee maker 600 in place on one end, and the measuring spoon extension tab 609 holds the coffee maker 600 on the opposite end. FIG. 14 shows The invention 100 stored in a molded plastic container 700. Accessories such as the baster 500, a match box 600, the fork attachment 130 and the whisk attachment 140 are also stored in that container 700. The container 700 includes a lid 702 that is hinged 703 and a cord holding tab 705 to hold hanging cord 710 as shown in FIG. 15. FIG. 16 shows handles 14, 16 attached by elastic cord 60. Spatula portion 40 is reversed so that the device 100 can be used as a tongs. Because scoop edge 8 mates with spatula edge 47, items such as salad and the like can be easily picked up and served. FIG. 17 is a perspective view of the scoop 50.

As the above description and drawings show, the present invention provides the storage and easy accessibly of plurality of commonly used kitchen utensils within a compact, versatile, novel configuration. Because many of the utensils of the present invention use a common handle, the resulting multi use invention is light weight and inexpensive to manufacture. As described above, the present invention can be used as a scoop, a ladle, a measuring cup, a measuring spoon, a serrated carving knife, a fork, a tongs, a strainer, a can opener, a paring knife, a bottle opener, a cork screw, a vegetable peeler, a whisk, a potato masher, a basting brush, a coffee maker, a grater, a spatula, a match box and a salt and pepper shaker.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Multi-purpose Kitchen Utensil comprising:
a flat temperature resistant member that incorporates the elements of a standard spatula, a serrated knife and a grater;
a first and second pair of handle members releasably joined to each other at one end;
said first handle member terminating at its opposite end in a scoop member;
said second handle member terminating at its opposite end in said flat spatula shaped member;
said handle members being foldable at said releasably joined junction so that said handles rest on top of each other and said flat spatula member rests intimately on the top perimeter of said scoop; and
said first and second handle members having recessed portions to allow for the storage of a plurality of kitchen tools.

2. Multi-purpose Kitchen Utensil as claimed in claim 1 further comprising an elastic cord member that attaches said first handle member to said second handle member to by means of an interlocking joint to removably retain said first and second handles from each other.

3. Multi-purpose Kitchen Utensil as claimed in claim 1 wherein said kitchen tools that are stored within said handle portions are pinned at one end within the said hollow portions of said handles so that said tools can swing out as needed.

4. Multi-purpose Kitchen Utensil as claimed in claim 1 further comprising a funnel member having a fine screened bottom that can nest into said scoop member do that said funnel can be used for retaining ground coffee or the like and said funnel member having opposing tabs at its top perimeter so that said funnel can be placed within a standard coffee cup and said tabs can hold said funnel in a suspended position within said coffee cup, one said tab terminating in a measuring spoon.

5. Multi-purpose Kitchen Utensil as claimed in claim 1 further comprising a salt and pepper shaker that are shaped to nest within said funnel member.

6. Multi-purpose Kitchen Utensil as claimed in claim 1 further comprising a storage case made of molded plastic, or alternately made of cloth such as a sewn pouch, each capable of removably retaining said multi-purpose utensil and additional items such as a basting brush, additional tool heads or a match box or the like.

7. Multi-purpose Kitchen Utensil as claimed in claim 1 wherein said kitchen tools stored within said handles include a cork screw, a bottle opener, a can opener and a vegetable peeler.

8. Multi-purpose Kitchen Utensil as claimed in claim 1 wherein said said flat spatula member can rest on the top perimeter of said scoop member so that the grater apertures located in said flat member can act as a strainer allowing liquid to pass through said apertures but not allowing food item such as small vegetables residing in said scoop to pass through.

9. Multi-purpose Kitchen Utensil as claimed in claim 1 wherein said flat spatula member can be turned over so that the flat tip of said flat member can touch the flat tip of said scoop thereby allowing the flat member and scoop member to act as a tong.

10. Multi-purpose Kitchen Utensil as claimed in claim 1 wherein said scoop member includes a plurality of raised ribs and associated indices located on the internal walls of said scoop so that said scoop can act as a measuring cup.

11. Multi-purpose kitchen utensil as claimed in claim 1 wherein said utensil is capable of assisting in performing the tasks of scooping, ladling, grating, cutting, whisking, mashing, basting, bottle opening, can opening, coffee making, peeling, measuring, straining scraping and cork removing.
